(19) United States
(12) Patent Application Publication
(10) Pub. No.: US 2011/0296131 A1
(43) Pub. Date: Dec. 1, 2011

(54) NONVOLATILE MEMORY SYSTEM AND THE OPERATION METHOD THEREOF

(75) Inventors: Yong Tae YIM, Suwon-si (KR); Won Moon CHEON, Hwaseong-si (KR); Jin Yeong KIM, Suwon-si (KR); Du-Won HONG, Suwon-si (KR); Jong-Min KIM, Hwaseong-si (KR)

(73) Assignee: Samsung Electronics Co., Ltd, Suwon-si (KR)

(21) Appl. No.: 13/117,352

(22) Filed: May 27, 2011

(30) Foreign Application Priority Data
May 31, 2010 (KR) 10-2010-0051238
Dec. 16, 2010 (KR) 10-2010-0129334

(51) Int. Cl. G06F 12/02

(52) U.S. Cl. 711/165; 711/E12.002

(57) ABSTRACT

A memory controller includes a microprocessor, a queue configured to store a plurality of first commands provided by the microprocessor, a queue management block configured to interpret and control said plurality of first commands, and a command generator configured to provide a plurality of second commands under control of the queue management block. The queue management block may simultaneously perform the plurality of second commands so as to simultaneously access a plurality of non-volatile memory units.

### CROSS-REFERENCE TO RELATED APPLICATIONS

This application claims the benefit priority under 35 U.S.C. §119 of Korean Patent Application Nos. 10-2010-0051238, filed on May 31, 2010, and No. 10-2010-0129334, filed on Dec. 16, 2010, in the Korean Intellectual Property Office, the disclosure of which is incorporated herein in its entirety by reference.

### BACKGROUND

1. Field of the Invention

The present general inventive concept relates to a non-volatile memory system and method.

2. Description of the Related Art

A memory system (i.e. SSD) has a plurality of non-volatile memory units (or flash memory units, which may include separate flash memory chips or different segments of a chip). A microprocessor inside the memory system controls and intervenes repeatedly in order to operate a plurality of commands corresponding to the non-volatile memory units. Whenever non-volatile memory carries out a command or is the subject of the command, the microprocessor controls each command operation and controls the non-volatile memory performance. The intervention of the microprocessor may cause an overload and may delay the performance of a command from a host.

### SUMMARY

The present general inventive concept provides a memory system that may control operations of non-volatile memory units or devices independently of a microprocessor that sends commands to the non-volatile memory units.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a plurality of non-volatile memory units and a memory controller including a microprocessor, a queue having a plurality of first commands provided by the microprocessor, a queue management block configured to interpret and control the plurality of first commands and a command generator configured to provide a plurality of second commands under control of the queue management block. Each one of the second commands may correspond to at least a selected one of the plurality of first commands and at least one of the plurality of non-volatile memory units. The plurality of memory units may be configured to perform the plurality of second commands simultaneously

Features and/or utilities of the present general inventive concept may also be realized by a memory system including a plurality of non-volatile memory units, a queue configured to store a compaction command, a source block, a target block provided by a microprocessor, a queue management block configured to interpret and control the compaction command and a page bit map which identifies a valid status of each one of a plurality of the pages in the source block, and a command generator to provide the non-volatile memory units with a copy back read command for the pages in the source block and a copy back program command for pages in the target block under control of the queue management block. The memory system may further include a volatile memory chip configured to store the page bit map.

Alternatively, the page bit map could be stored in the queue.

The compaction command may be performed independently of the microprocessor.

Features and/or utilities of the present general inventive concept may also be realized by a method of controlling non-volatile memory, the method including receiving at least one first command corresponding to a plurality of non-volatile memory units, converting the first command into a plurality of second commands to control an operation of the plurality of non-volatile memory units, and simultaneously executing the plurality of second commands to simultaneously perform operations on the plurality of non-volatile memory units.

The first command may be received from a microprocessor, and the plurality of second commands may be executed independently of the microprocessor.

The method may further include, after executing the plurality of second commands, transmitting to the microprocessor a signal indicating that the at least one first command has been executed.

Features and/or utilities of the present general inventive concept may also be realized by a method of controlling non-volatile memory, the method including receiving from a microprocessor a first command corresponding to at least one non-volatile memory unit, converting the first command into at least one second command, and completing the first command by executing the at least one second command to access the at least one non-volatile memory unit, wherein executing the at least one second command is carried out independently of the microprocessor.

Features and/or utilities of the present general inventive concept may also be realized by a memory controller including a queue to store at least one first command received from a microprocessor to access at least one non-volatile memory and a queue management block to convert the at least one first command into at least one second command and to access the at least one non-volatile memory according to the at least one second command independently of the microprocessor.

Features and/or utilities of the present general inventive concept may also be realized by a memory controller including a queue to store at least one first command received from a microprocessor to access a plurality of non-volatile memory units, and a queue management block to convert the at least one first command into a plurality of second commands to simultaneously access the plurality of non-volatile memory units.

The queue management block may access the plurality of non-volatile memory units independently of the microprocessor.

The memory controller may further include a command generator, and the queue management block may control the command generator to convert the at least one first command into the plurality of second commands.

The memory controller may further include an interrupt generator to transmit to the microprocessor a signal indicating completion of the at least one first command upon completion of the plurality of second commands.

The at least one first command may be a compaction command including at least a source block address and a target block address, converting the first command into the plurality of second commands may include converting the compaction command into a plurality of sub-compaction commands, and simultaneously accessing the plurality of non-volatile memory units may include executing copy back read commands for pages in the source block and copy back program commands for pages in the target block.

The memory controller may further include the microprocessor and a host interface to receive a third command from a host to cause the microprocessor to generate the at least one first command.

Features and/or utilities of the present general inventive concept may also be realized by an electronic device including an application chipset to enable the electronic device to perform a particular application, at least one memory unit to store data, and a CPU to control the application chipset to execute the application and to control the memory unit to access the memory. The at least one memory unit may include a plurality of non-volatile memory units, a microprocessor, a queue to store at least one first command received from the microprocessor to access the plurality of non-volatile memory units, and a queue management block to convert the at least one first command into a plurality of second commands to simultaneously access the plurality of non-volatile memory units.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a block diagram showing a non-volatile memory (i.e. flash memory) based memory system according to embodiments of a present general inventive concept.

FIG. 2. shows a NAND flash cell array.

FIGS. 3A and 3B show the timing diagram of a copy back program operation of a memory system according to an embodiment of the present general inventive concept.

FIG. 4 shows a flow chart of the process of the first command performance.

FIG. 5 shows a flow chart of the process of the compaction command performance.

FIG. 6 shows an exemplary embodiment related to sub-compaction.

FIG. 7 shows an electronic device according to an exemplary embodiment of the present general inventive concept.

FIG. 8 shows a block diagram of a computer system.

FIG. 9 shows a block diagram of an electronic device including a non-volatile memory device according to another exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

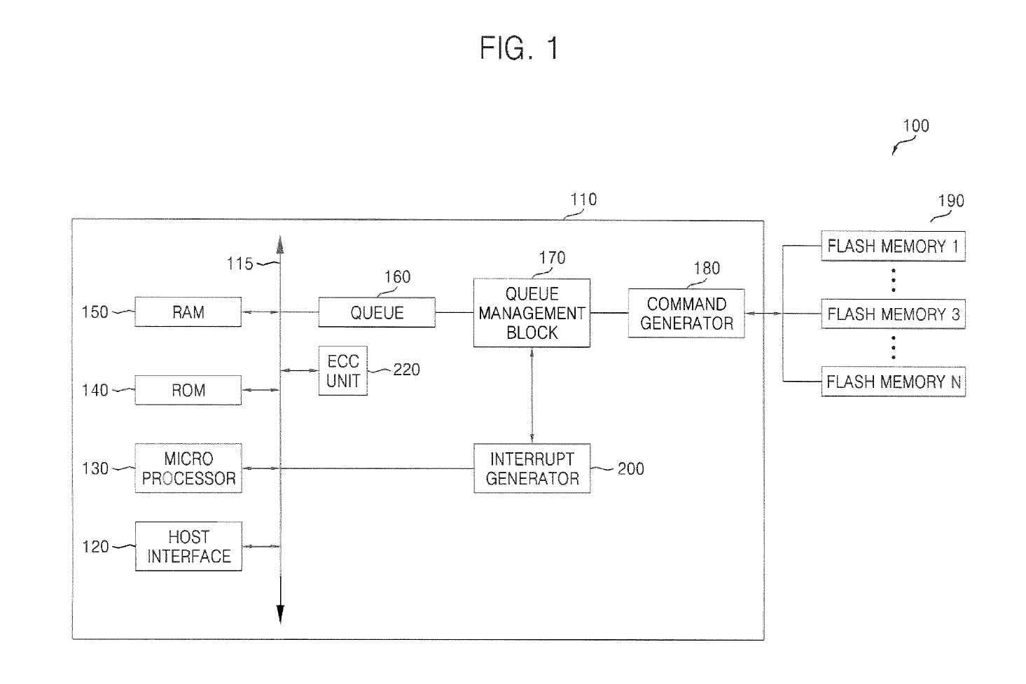

FIG. 1 is a block diagram showing a non-volatile memory (e.g., flash memory) based memory system 100 according to an embodiment of the present general inventive concept.

Referring to FIG. 1, the memory system 100 having non-volatile memory (or flash memory) 190 includes a memory controller 110 and non-volatile memory (or flash memory) 190. The non-volatile, or flash, memory 190 may be made up of one or more units, which may correspond to separate memory chips or to different segments within a same chip.

The memory controller 110 includes a bus 115, a host interface 120, a microprocessor 130, ROM (read only memory) 140, RAM (random access memory) 140, a queue 160, a queue management block 170, a command generator 180, flash memory 190, an interrupt generator 200, and an ECC unit 220.

The above-described elements of the memory controller 110 may be electrically connected via the bus 115. The microprocessor 130 generally controls the operation of the memory system 100. The host interface 120 is configured to communicate between the memory system 100 and a host (not shown). The queue 160 may sequentially store a plurality of commands (“the first command”) and the plurality of parameters which are needed for the operation of memory system 100.

The microprocessor 130 is configured to provide the first command and the parameters to the queue 160. The first command may be provided by the microprocessor 130 in the memory controller 110 and stored in the queue 160. The first command may not directly control the memory device 190. Instead, the first command may be a command received by the memory system 100 through the host interface 120 that is converted into one or more second commands to control read and write operations of the flash memory units 190.

The queue 160 may include one or more memory units, or predetermined portions of one or more memory units, and one or more logic circuits to perform functions of the queue 160. The queue 160 may include one or more registers. The queue 160 may include a program stored in memory that may be accessed and carried out by the microprocessor 130 to control the read/write operations of data into portions of memory dedicated to the queue 160.

The queue management block 170 may control the queue 160. The queue management block 170 may be configured to interpret and control a plurality of commands stored in the queue 160 by a selected sequence.

The queue management block 170 may interpret and control the first commands independently of the microprocessor. In other words, the queue management block 170 may interpret and control the commands in the queue 160 without additional intervention of the microprocessor 130. In other words, the queue management block 170 may interpret and control the commands stored in the queue 160 without any direction or intervention from the microprocessor 130 after the commands are stored in the queue 160.

The microprocessor 130 may control contents of the queue 160 and operations of the memory controller 110 via firmware.

The queue management block 170 may include one or more processors, logic units, and memory units that are each independent of the microprocessor 130. The microprocessor 130 may control the queue 160 to store commands in the queue 160, and then the queue management block 170 may access the commands stored in the queue 160 and may perform or initiate operations to control the memory units 190 indicated by the commands stored in the queue 160.

Therefore, the queue management block 170 is configured to interpret and control the plurality of the first commands stored in the queue 160 and may control the flash memory units 190 to simultaneously perform second commands that correspond to the first commands but are further optimized for flash memory operation. The second commands may directly be applied to the memory device 190, while the first commands provided from the microprocessor 130 may not be directly applied to the memory device 190. In other words, the microprocessor 130 may store general read/write commands in the queue 160 to read/write data of the flash memory 190, but the read/write commands from the microprocessor 130 may not be able to directly carry out read/write operations of the flash memory 190. Instead, the queue management block 170 may interpret the read/write commands from the microprocessor 130 into specialized read/write commands that are specific to the flash memory 190 and may control the read/write operations of the flash memory 190 with the specialized read/write commands.

Once the first commands from the microprocessor 130 are stored in the queue 160, the queue management block 170 may control the queue 160 without additional intervention or control from the microprocessor. Consequently, the queue management block 170 may reduce the intervention time and overhead of the microprocessor 130 or firmware. Accordingly, it is possible to improve the overall performance of the memory controller 110.

The interrupt generator 200 is electrically connected to the queue management block 170 and communicates with the queue management block 170 and the microprocessor 130. The interrupt generator 200 may provide an interrupt signal to the microprocessor 130 upon completion of the first command. In other words, once each of the second commands is completed to perform the read/write operations indicated by the first commands, the interrupt generator 200 may generate and interrupt to notify the microprocessor 130 of the completion of the first commands. From the point of view of the microprocessor 130, a command is sent out and a notification of the completion of the command is received. The microprocessor 130 does not control and need not monitor the generation of the second commands to carry out the operations indicated by the first commands.

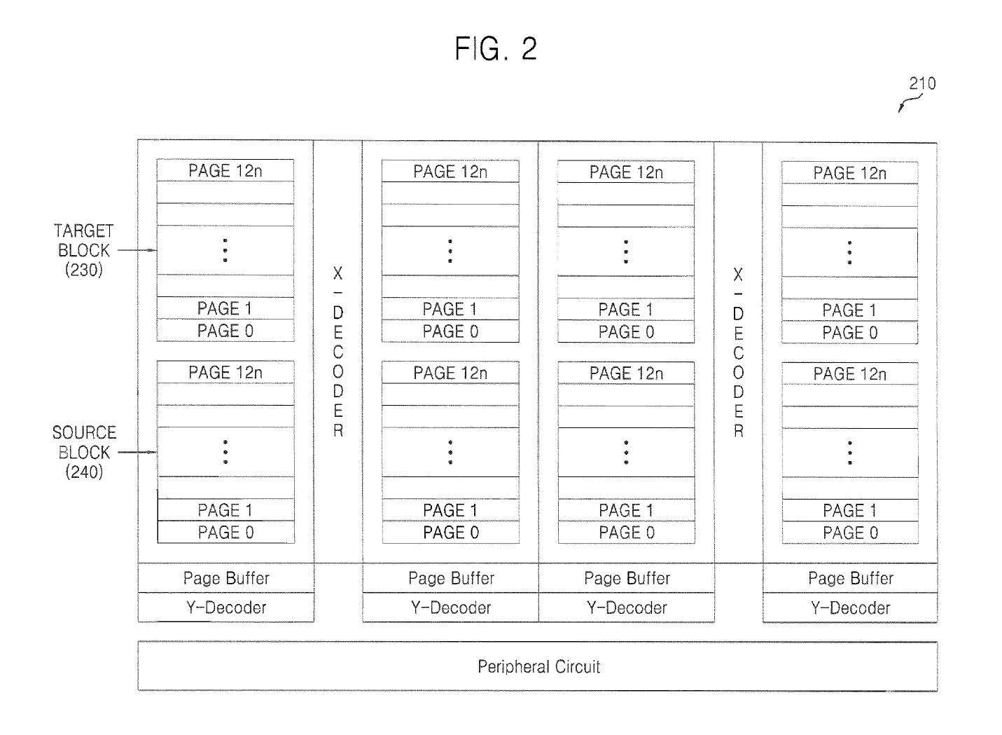

FIG. 2. shows a NAND flash cell array 210 according to an embodiment of the present general inventive concept. The compaction may be performed by a copy back program operation of NAND flash memory. The copy back program operation moves the data from one page in the source block 240 to another page in the target bock 230, which may be carried out with respect to each of pages in one memory block at a merge operation well known in the art.

The microprocessor 130 determines which portions are suitable for compaction and the firmware may transfer the logical address to the physical address where the compaction operation is to be performed in the flash memory 190. The microprocessor 130 may store the physical address for the source block 240 and target block 230 into queue 160 using the firmware, and may produce bit map which shows valid status of the source block 240, or in other words, which shows whether each page of the source block 240 is a valid or an invalid page. For example, when the bit map uses the binary digit, 1 or 0, the 1 may stand for a valid page among the plurality of pages in the source block 240, and the 0 may stand for an invalid page among the plurality of pages in the source block 240. The microprocessor 130 stores the bit map into RAM 150 or the queue 160. The RAM 150 could be volatile memory such as DRAM well known in the art.

Next, the microprocessor 130 may provide the queue 160 with the compaction command. Once the compaction command is stored in the queue 160, the queue management block 170 may interpret the command and the bit map. For example, the queue management block 170 may determine whether the next page is valid or invalid when the bit map shows a first page is invalid, that is “0”. The queue management block 170 may control the command generator 180 to produce the read command when the bit map shows that the next page is valid, for example, a “1”.

Referring to FIG. 1, the memory controller 110 may include an ECC (error correction code) unit 220. The ECC unit 220 is configured to detect the data errors among the data which come from the memory device 190 in response to a read command. The ECC unit 260 is also configured to correct the errors and provides the flash memory 190 with the error corrected data.

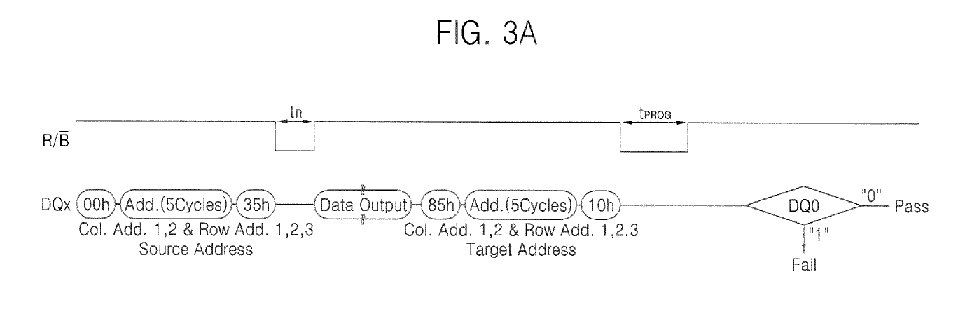

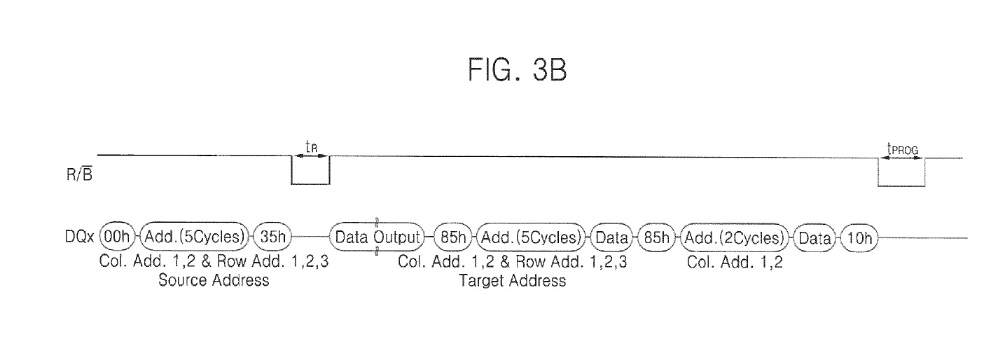

FIGS. 3A and 3B show timing diagrams illustrating a copy back program operation of a memory system 100 according to an embodiment of the present general inventive concept. The command generator 180 may generate the copy back command. The copy back read command (00 h, 35 h) may be applied to the valid pages among pages of the source bock 240.

When an error is not detected based on the result in response to the read command, (FIG. 3A) the copy back program command (85 h, 10 h) is applied to the target block 230. Then a program operation for the pages of the target block 230 may be started.

As shown in FIG. 3B, when an error occurs while the read operation is performed, the error corrected data are loaded to the flash memory 190 while the copy back program performs. FIG. 3B shows that the additional data are loaded to flash memory 190 after the copy back program command is set. In other words, it is possible to correct the errors through random-in and random out while the copy back program is being performed.

Once the copy back program has been performed in the first page of target block 230, the copy back program of the first valid page is completed. And then, the same steps are repeated for the next valid pages of the source block 240. In other words, the command generator 180 repeatedly sends copy back read commands to the all valid pages of source block 240 and copy back program commands to the pages of target block 230. At this time, the bit map for target block is not necessarily needed. The target block page address may serially increment from the program starting page address. But, when the flash memory 190 supports the random programming, the bit map of the target block 230 may be needed and the bit map may be stored in the queue 160 or the RAM 150.

According to FIG. 1, the queue management block 170 controls the first commands in the queue 160 related to the different flash memory units while the compaction operation is performed. The first commands from the microprocessor 130 may be sequentially stored in the queue 160. For example, the compaction command for the first NAND flash, the read command for the second NAND flash, and the program command for the third NAND flash may be sequentially stored in the queue 160.

The queue management block 170 controls a plurality of commands related to multiple NAND flash operation by selected sequence. The queue management operation allows multiple memory units to perform simultaneously, or to be the subject of read/write commands simultaneously, without additional intervention or control from the microprocessor 130. In other words, a plurality of memory units may operate independently of the microprocessor 130 mentioned. The interleaving between the multiple flash memory units 190 may be carried out by the hardware, namely the queue management block 170. The interleaving of the flash memory units may reduce the standby time between NAND flash memory units, or in other words, may reduce the time that is spent waiting to perform a read/write operation on one flash memory chip due to a read/write operation of another flash memory chip.

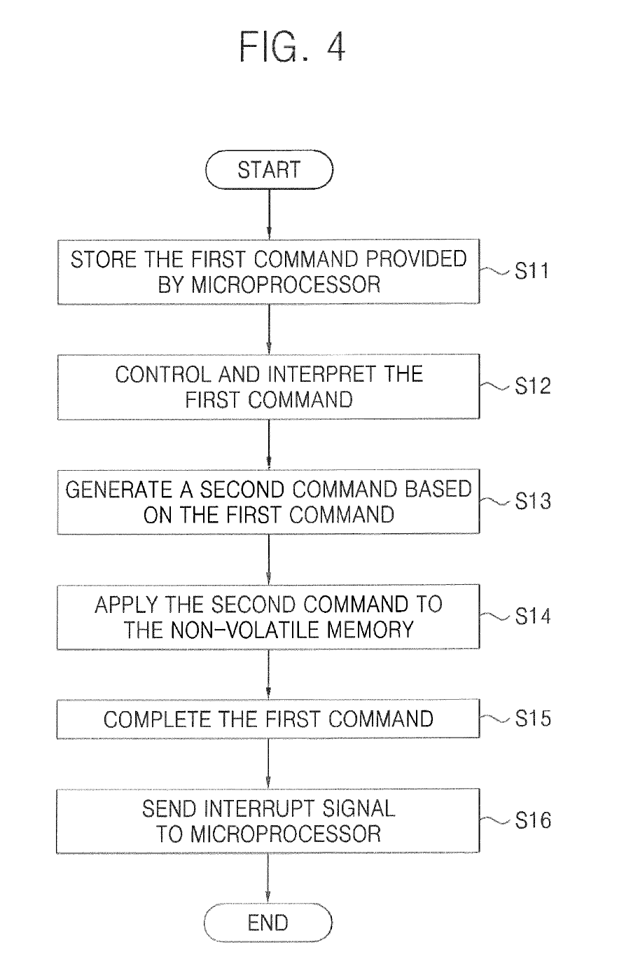

FIG. 4 is a flow chart illustrating a process to carry out a first command from the microprocessor 130 using second commands.

In operation S11, a first command is received from microprocessor 130 and stored in the queue 160. The queue management block 170 may interpret and control the first command stored in the queue 160 by a predetermined sequence. Based on the interpretation of the first command by the queue management block 170, the command generator 180 may generate in operation S13 a second command which is optimized to control the flash memory 190, and the second command may be applied to flash memory 190 in operation S14. The queue management block 170 monitors and determines whether the first command has been completed by monitoring whether the second command has been completed. Once it has been determined in operation S15 that the first command is completed, the queue management block 170 provides the interrupt generator 200 with a first command completion signal, and the interrupt generator 200 sends the interrupt signal to the microprocessor 130 in operation S16 to notify the microprocessor 130 that the first command is finished.

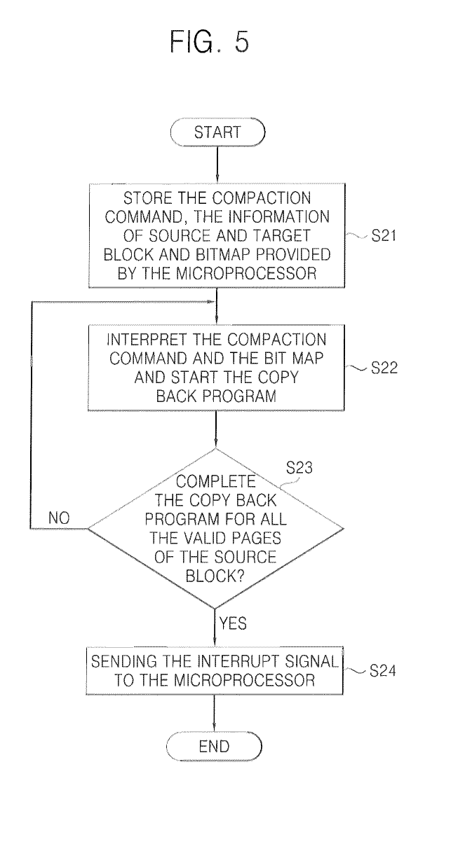

FIG. 5 is a flow chart illustrating a process of carrying out a compaction command.

In operation S21, a compaction command, address information of the source block 240 and the target block 230, and a bitmap provided by the microprocessor 130 may be stored in the queue 160. The bit map may alternatively be stored in the RAM 150.

In operation S22, the queue management block 170 may interpret the command and the bit map. The queue management block 170 may control the command generator 180 to generate a read command for the first valid page of the source block 240. As mentioned previously, the ECC unit 220 may detect the errors in the data of the pages of the source block 240 and, unless an error is found, a copy back program command may be applied to the target block 230 without loading additional data. On the other hand, if an error is found, the error corrected data may be transferred to the flash memory 190, and additional data may be loaded while the program is performed. The queue management block 170 may control the copy back program to the target block 230 based on the read data from the valid page of the source block 240.

Once the copy back program for the first page of the source block 240 is completed, the queue management block 170 manages and orders the copy back read and program for the next valid page of the source block 240. The queue management block 170 manages the repeated operations of each page corresponding to the copy back program until it is determined in operation S23 that all of the valid pages of the source block 240 are completed. Operations S22 and S23 are carried out under the control of the queue management block 170 without any intervention or control from the microprocessor 130. The copy back program may be performed independently of the microprocessor after the compaction command and bit map are stored.

Once the copy back program is finished for all the valid pages of the source block 240, the queue management block 170 notifies the interrupt generator 200, and the interrupt generator 200 may generate a compaction end interrupt signal and may transmit the interrupt signal to the microprocessor 130 in operation S24.

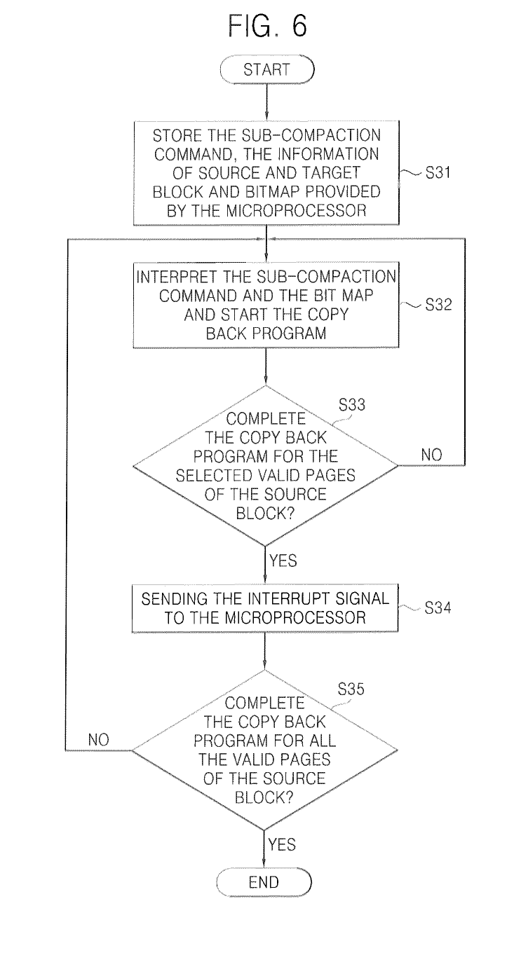

FIG. 6 is a flow chart illustrating a process of performing sub-compaction commands according to another embodiment of the present general inventive concept.

The compaction command for the source block 240 is divided to a plurality of the sub-compaction commands. The queue management block 170 performs a plurality of sub-compaction operations on the valid pages of the source block 240. The queue management block 170 controls the command generator 180 to repeatedly generate copy back read commands for the source block 240 on selected valid pages and copy back program commands of the target block 230.

Referring to FIG. 1 and FIG. 6, a sub-compaction command and the address information of the source block 240 and target block 230 which come from the microprocessor 130 are stored in the queue 160 in operation S31. A bit map, which shows a valid status of the source block 240 pages may be stored in the queue 160 or RAM 150. After the command and information are set up, queue management block 170 may interpret and control the command and the bitmap in operation S32. The command generator 180 may generate and apply the read command for the first page of source block 240. In response to the read command, the queue management block 170 may receive the read data and check errors via the ECC unit 220, for example. If there are no errors among the read data, the command generator 180 may generate and apply the copy back program command to the target block 230 without loading additional data. As mentioned previously, if there are errors among the read data, then the copy back program may be performed by loading additional corrected data.

When the copy back program for the first page of the source block 240 is finished, the queue management block 170 may perform the copy back program for the next valid page of the source block 240. The copy back program may be repeated until it is determined in operation S33 that the copy back program for each selected valid page of source block 240 is finished. In other words, the queue management block 170 may determine whether a copy back program of the selected valid pages of the source block 240 is completed.

A bitmap for the target block may not be necessary as mentioned previously. When the copy back program for all selected valid pages of source block 240 is finished, the queue management block 170 provides the interrupt generator 200 with a copy back program completion signal for the selected valid pages, and the interrupt generator 200 may send the interrupt signal, a sub-compaction completion signal, to the microprocessor 130 in operation S34. Then, microprocessor 130 may manage a copy back program for the next selected valid pages of the source block 240. In other words, the queue management block 170 may check in operation S35 whether the copy back program for all the valid pages of the source block 240 is completed. If not completed, operations S32, S33, and S34 may be repeated for the next selected valid pages of the source block 240.

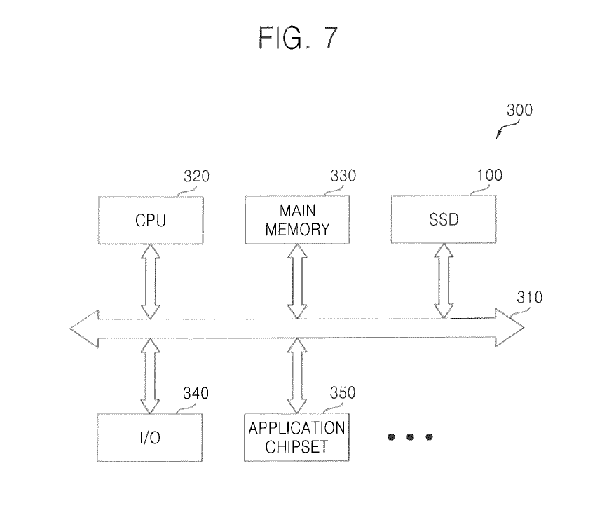

FIG. 7 shows an electronic device 300 according to an exemplary of the present general inventive concept.

Referring to FIG. 7, the electronic device 300 may include CPU 320, main memory 330, a memory system or SSD 100, input/output (I/O) 340, and an application chip set 350. These elements may be electronically connected through system bus 310 inside the electronic device 300.

The CPU 320 may include one or more processors, and supporting logic and memory, such as cache memory. The main memory 330 may include RAM, ROM, non-volatile memory, a hard disk drive HDD, or any other type of memory. The I/O 340 may include one or more data ports to transmit and receive data, and it may include one or more interfaces to receive inputs from a user, such as a keyboard, touch pad, etc. The application chipset 350 may include one or more processors, logic circuitry, and supporting circuitry according to the different applications to be performed by the electronic device. For example, if the electronic device is an MP3 player, it may utilize a different application chipset 350 than a camera, printer, or computer. One electronic device 300 may include several application chipsets 350 to support several different types of applications, such as audio functions, video functions, image capture functions, printing functions, etc.

The electronic device 300 may be a laptop, personal computer, MP3, personal digital assistance and digital camera, or any other type of electronic device that utilizes non-volatile memory.

The electronic device 300 includes SSD 100 which may be used as a substitute for a hard disc drive (HDD). In such a case, the electronics device 300 may have advantages compared to electronic devices having HDDs. For example, the electronic device 300 of FIG. 7 may have a faster read/write speed to the non-volatile memory, may have less mechanical latency, may be less noisy, may generate less heat, may be lighter, and may be smaller or more compact relative to a similar device that includes an HDD.

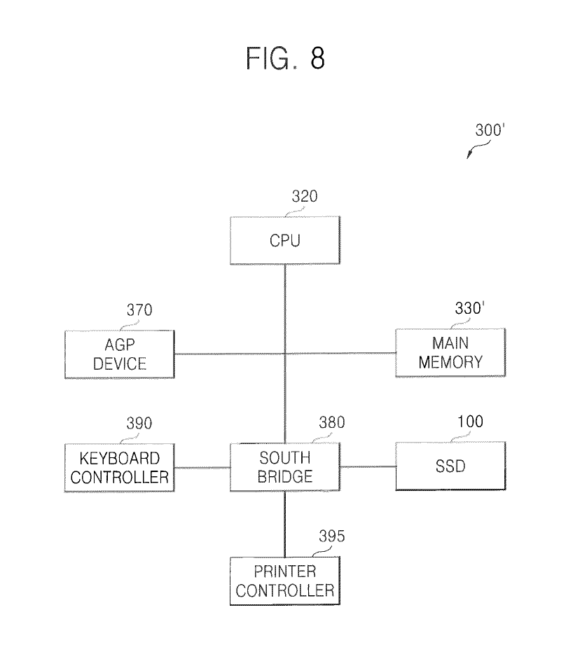

FIG. 8 shows a block diagram of computer system 300′ according to an embodiment of the present general inventive concept. The computer system 300′ may be one of the exemplary of the electronics device 300, as described with respect to FIG. 7.

Referring to FIG. 8, the computer system 300′ may include a CPU 320, an AGP device 370, main memory 330′, a keyboard controller 390, south bridge 380, a memory system or SSD 100, and a printer controller 395.

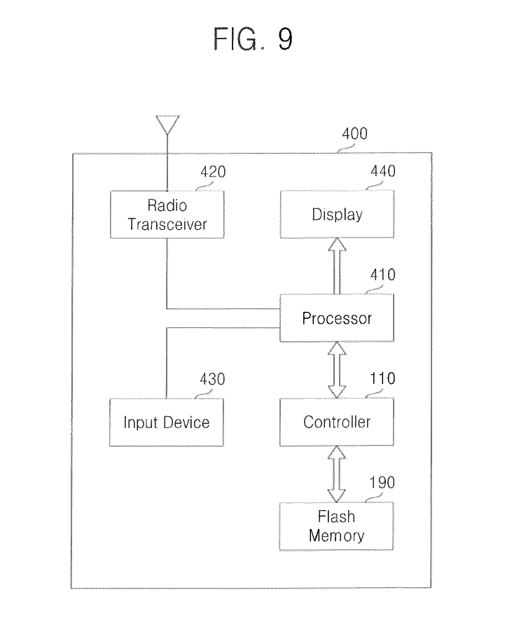

FIG. 9 shows a block diagram of an electronic device 400 including the non-volatile memory device 110 according to an example embodiment of the present general inventive concept.

Referring to FIG. 9, an electronic device 400 such as a cellular phone, a smart phone, or a tablet PC may include a non-volatile memory 190, which may be embodied in a flash memory device such as one or more flash memory units or chipsets, and a memory controller 110, which may control an operation of the non-volatile memory device 190.

The non-volatile memory 190 may correspond to the non-volatile memory 190 illustrated in FIG. 1. The controller 110 may correspond to the controller 110 illustrated in FIG. 1.

Data stored in the non-volatile memory device 190 may be displayed through a display 440 according to a control of the controller 110 operating under control of the processor 410. In other words, the processor 410 may function as the host, described previously with respect to FIG. 1. The processor 410 may transmit a command to the controller 110 to access the flash memory 190, and the controller 110 may queue the command and control access of the flash memory 190 with a queue management block 170, as described above.

A wireless transceiver 420 may transmit or receive a wireless signal through an antenna ANT. For example, the wireless transceiver 420 may convert a received wireless signal received through the antenna ANT to a signal which the processor 410 may process. Accordingly, the processor 410 may process a signal output from the wireless transceiver 420, and may store a processed signal in the non-volatile memory device 190 through the memory controller 110 or display it through the display 440.

The wireless transceiver 420 may convert a signal output from the processor 410 to a wireless signal and output a converted wireless signal to outside through the antenna ANT.

An input device 430 is a device which may input a control signal for controlling an operation of the processor 410 or data to be processed by the processor 410, and it may be embodied in a pointing device such as a touch pad and a computer mouse, a keypad, or a keyboard.

The processor 410 may control the display 440 to display data output from the non-volatile memory device 190. In addition, a wireless signal output from the wireless transceiver 420 or data output from the input device 430 may be displayed through the display 440.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present invention have been shown and described, it would be appreciated by those skilled in the art that changes may be made in these embodiments without departing from the principles and spirit of the general inventive concept, the scope of which is defined in the claims and their equivalents.

1.-8. (canceled)

9. A controller comprising:
a queue configured to store a compaction command, address information of a source block, and address information of a target block provided by a microprocessor;
a queue management block configured to interpret and control the compaction command and a page bit map which identifies a valid status of each one of a plurality of pages in the source block; and
a command generator to provide a non-volatile memory unit with a copy back read command for the pages in the source block and a copy back program command for pages in the target block under control of the queue management block.

10. The controller of claim 9, further comprising:
a volatile memory configured to store the page bit map.

11. The controller of claim 9, wherein the page bit map is stored in the queue.

12. The controller of claim 9, wherein the compaction command is performed independently of the microprocessor.

13. The controller of claim 9, further comprising an ECC unit,
wherein the controller is configured to correct an error using the ECC unit and the controller sends the copy back program command to the memory units with corrected data by the ECC unit.

14. The controller of claim 9, wherein the queue is configured to store a plurality of commands other than the compaction command while the compaction command is performed.

15. The controller of claim 9, wherein the queue management block is configured to interpret and control the plurality of commands in a selected sequence.

16. The controller of claim 9, wherein an address of the target block serially increments from a program starting page which programs the read data of a first valid page of the source block having valid pages.

17.-19. (canceled)

20. A method of compaction in a memory system, comprising:
storing a compaction command, address information of a source block and address information of a target block, and a page bit map which identifies a valid status of each one of a plurality of the pages in source block provided by a microprocessor in a queue;
interpreting and controlling the compaction command, the address information, the page bit map under control of a queue management block; and
repeatedly providing non-volatile memory with a copy back read command for the pages in the source block and a copy back program command for pages in the target block.

21. The method of claim 20, wherein interpreting and controlling the compaction command are performed independently of the microprocessor.

22. The method of claim 20, further comprising:
generating a compaction completion interrupt signal when the compaction is completed; and
providing the compaction completion interrupt signal to the microprocessor.

23. The method of claim 20, further comprising;
correcting an error using an ECC unit among the data read by the copy back read command.

24. The method of claim 23, further comprising:
providing the copy back program command for the pages in the target block with the error corrected data.

25.-38. (canceled)

39. A method of controlling non-volatile memory, the method comprising:
receiving from a microprocessor a first command corresponding to at least one non-volatile memory unit;
converting the first command into at least one second command; and
completing the first command by executing the at least one second command to access the at least one non-volatile memory unit,
wherein executing the at least one second command is carried out independently of the microprocessor.

40. A memory controller, comprising:
a queue to store at least one first command received from a microprocessor to access at least one non-volatile memory; and
a queue management block to convert the at least one first command into at least one second command and to access the at least one non-volatile memory according to the at least one second command independently of the microprocessor.

41. A memory controller, comprising:
a queue to store at least one first command received from a microprocessor to access a plurality of non-volatile memory units; and
a queue management block to convert the at least one first command into a plurality of second commands to simultaneously access the plurality of non-volatile memory units.

42. The memory controller of claim 41, wherein the queue management block accesses the plurality of non-volatile memory units independently of the microprocessor.

43. The memory controller of claim 41, further comprising a command generator,
wherein the queue management block controls the command generator to convert the at least one first command into the plurality of second commands.

44. The memory controller of claim 41, further comprising an interrupt generator to transmit to the microprocessor a signal indicating completion of the at least one first command upon completion of the plurality of second commands.

45. The memory controller of claim 41, wherein the at least one first command is a compaction command including at least a source block address and a target block address,
converting the first command into the plurality of second commands includes converting the compaction command into a plurality of sub-compaction commands, and
simultaneously accessing the plurality of non-volatile memory units includes executing copy back read commands for pages in the source block and copy back program commands for pages in the target block.

46. The memory controller of claim 41, further comprising:
the microprocessor; and
a host interface to receive a third command from a host to cause the microprocessor to generate the at least one first command.

47. The memory controller of claim 41, further comprising:
ECC unit configured to correct an error bit.

48. (canceled)
